(19) United States
(12) Patent Application Publication
(10) Pub. No.: US 2008/0310946 A1
(43) Pub. Date: Dec. 18, 2008

(54) Blade Cover

(76) Inventor: John T. Allen, Cleveland, TN (US)

Correspondence Address: PITTS AND BRITTIAN P C, P O BOX 51295, KNOXVILLE, TN, 37950-1295, US

(21) Appl. No.: 11/764,328

(22) Filed: Jun. 18, 2007

(51) Int. Cl. B66F 9/18

(52) U.S. Cl. 414/785; 29/592

(57) ABSTRACT

A blade cover for enclosing and padding the blade of a forklift truck having a toe extending from the forklift, and associated method for manufacture. The blade cover includes a sleeve shaped to substantially surround the toe. The sleeve defines an opening for receiving the blade distal. A support structure is shaped to substantially register with the toe. The support structure is secured within the sleeve and is configured to support the sleeve in a substantially open configuration.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention relates to industrial forklift trucks. More specifically, this invention relates to a device to cover a lift blade of a forklift truck.

2. Description of the Related Art

Forklift trucks are commonly used to lift and carry materials stacked on pallets which are often constructed of wood or plastic. A forklift truck typically employs a laterally spaced pair of load bearing cantilevered blades having sharpened distal ends to intrude beneath a pallet or other such load. The blades are carried by a vehicle employing a lift system for lifting the load bearing blades once positioned beneath the selected load. Forklift trucks are often required to be maneuvered in narrow isles and in other confined areas. As a result of the requirement for precise maneuverability, loaded pallets are often damaged by being struck directly by the lift blade.

Forklift trucks are often used to load and unload materials from the trailer of a transfer truck. Experience has shown that the side walls of the trailer are often pierced by the forward extending blades as the forklift truck is maneuvered within the trailer. Such piercing of the trailer side walls is undesirable, thus often requiring a forklift truck operator to exercise particular care and attention in operating the forklift truck near the trailer of a transfer truck.

Forklift trucks are also used to lift barrels and other such containers. In these applications, the forklift blade is capable of piercing the container. If the pierced container holds ink or other materials, the result is merely time lost due to the inconvenience of cleaning a messy spill. If the container holds petroleum, radioactive material or other hazardous materials, then the potential exists for serious injury or loss of life. Additionally, a bare metal forklift blade can create sparks when scraped against a concrete floor, a concrete pillar, or other such structure. This spark can create an explosion if it occurs in an environment laden with flammable vapors or volatile liquids.

### BRIEF SUMMARY OF THE INVENTION

A blade cover for enclosing and padding the blade of a forklift truck and associated method for manufacture are disclosed. The blade cover includes a support structure substantially surrounded by a sleeve. The sleeve is shaped to surround and substantially encapsulate the toe of a lift blade. The sleeve defines an opening adapted to receive the toe.

The support structure is provided to support the sleeve in a substantially open configuration. The support structure defines a first surface and a second surface joined proximate an end opposite the opening. The first and second surfaces are adapted to extend toward the opening and are shaped to substantially register with top and bottom surfaces of a lift blade. The support structure further defines at least one hook shaped to engage and retain the sleeve. In several embodiments, a fastener means such as a nut and bolt assembly or other fastener is provided to fasten the blade cover to a lift blade.

In the method of manufacture, a support structure is formed of a substantially rigid material. The support structure is then placed into a plurality of molds defining a volume for forming the sleeve. The molds define at least one port for receiving a measure of moldable material into the volume. An amount of uncured moldable material is forced by an injection molding apparatus into the volume. The uncured moldable material is then cured, forming the sleeve around the support structure. The first and second molds are then removed from the support structure and sleeve. At an optional step, suitable openings are cut into the support structure and sleeve to accommodate fasteners for securing the blade cover to a lift blade.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a blade cover constructed in accordance with several features of the present invention;

FIG. 2 is a cross-sectional side view of the embodiment of the blade cover taken along 2-2 of FIG. 1;

FIG. 3 is a cross-sectional side view of the support structure of FIG. 2;

FIG. 4 is an exploded view of the embodiment of the blade cover of FIG. 1;

FIG. 5 is an exploded view showing a support structure and molds for forming a covering;

FIG. 6 is a cross-sectional side view of the support structure and molds taken along 6-6 of FIG. 5, showing the injection of material for forming the cover;

FIG. 7 is a cross-sectional side view of the support structure and molds of FIG. 6, showing the material for forming the cover in place for curing; and

FIG. 8 is a perspective view of one embodiment of a cured blade cover.

### DETAILED DESCRIPTION OF THE INVENTION

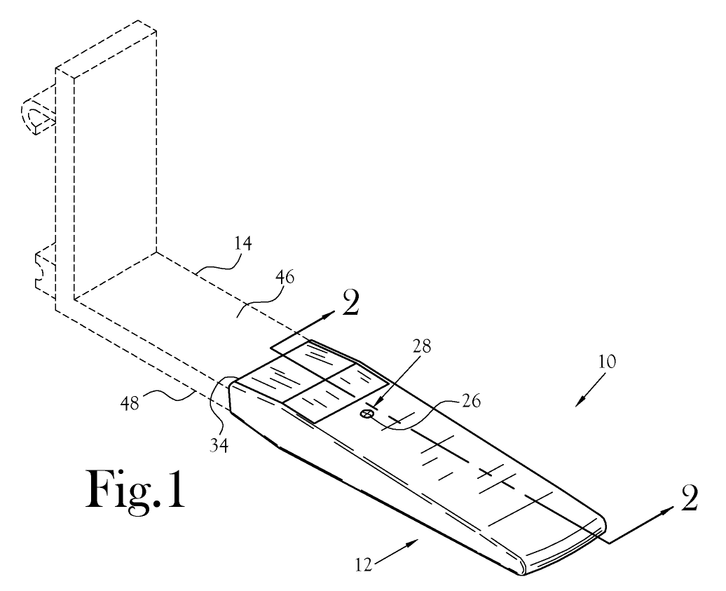

Accordingly, a blade cover for enclosing and padding the blade of a forklift truck and associated method for manufacture are disclosed. One embodiment of a blade cover is illustrated generally at 10 in the FIG. 1. The typical forklift truck generally provides at least one forward extending lift blade 14 having a top surface 46 and a bottom surface 48. The portion of the lift blade 14 distal from the forklift truck is the toe 12. The blade cover 10 is adapted to be fitted over the toe 12 of a lift blade 14 of a forklift truck.

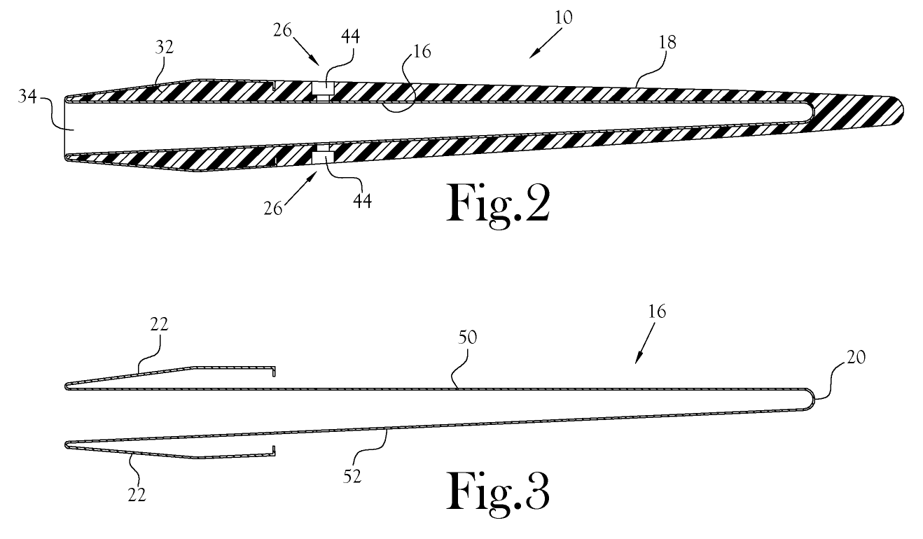

FIG. 2 illustrates a cross-sectional view of one embodiment the blade cover 10. Referring to FIG. 2, the blade cover 10 includes a support structure 16 substantially surrounded by a sleeve 18. The sleeve 18 is constructed of a compressible, resilient material such as, but not limited to, rubber, glass fabric such as Kevlar®, polymer, or other such material. The sleeve 18 is shaped to surround and substantially encapsulate the toe of a lift blade. The sleeve 18 defines an opening 34 adapted to receive the toe.

The support structure 16 is provided to support the sleeve 18 in a substantially open configuration. Referring to FIG. 3, the support structure 16 is constructed of a substantially rigid material such as, but not limited to, metal, polymer, or other such substantially rigid material. The support structure 16 defines a first surface 50 and a second surface 52 joined proximate an end 20 opposite the opening 34. The first and second surfaces 50, 52 are adapted to extend toward the opening 34 and are shaped to substantially register with the top and bottom surfaces 46, 48, respectively, of a lift blade (See FIG. 1).

Referring now to FIGS. 2 and 3, the support structure 16 further defines at least one hook 22 shaped to engage and retain the sleeve 18. The hook 22 extends from a region proximate the opening 34 away from the opening 34 and expands from the first and second surfaces 50, 52 to cover a portion of the sleeve 18. The hook 22 is joined to at least one of the first and second surfaces 50, 52 proximate the opening 34. In the illustrated embodiment, the hooks 22 and the first and second surfaces 50, 52 are shown as integrally formed. Those skilled in the art will recognize other configurations suitable for forming the hook 22 which may be used without departing from the spirit and scope of the present invention. To this extent, a support structure 16 defined by a hook 22 secured to at least one of the first and second surfaces 50, 52 is contemplated. In the illustrated embodiment, two hooks 22 are provided, with one hook 22 being integrally formed with each of the first and second surfaces 50, 52. In other embodiments, a single hook 22 is provided, joined to one of the first and second surfaces 50, 52.

The hook 22 engages a proximal portion 32 of the sleeve 18 to retain the sleeve 18 in place surrounding the first and second surfaces 50, 52. In more discreet embodiments, such as the illustrated embodiment, the sleeve 18 substantially registers to the hook 22, such that the interface between the hook 22 and the sleeve 18 is relatively smooth. In this configuration, the relatively smooth interface between the hook 22 and the sleeve 18 allows for the smooth transition of cargo across the blade cover 10. In the illustrated embodiment, the hook 22 and cooperating sleeve 18 gradually taper toward the opening 34, such as to provide a substantially smooth transition between the hook 22 and the lift blade 14. Such tapering prevents the presence of a large “shoulder” at the junction of the blade cover 10 and the lift blade 14 that would engage the interior edge of a pallet when the lift blade 14 with blade cover 10 is withdrawn from the pallet.

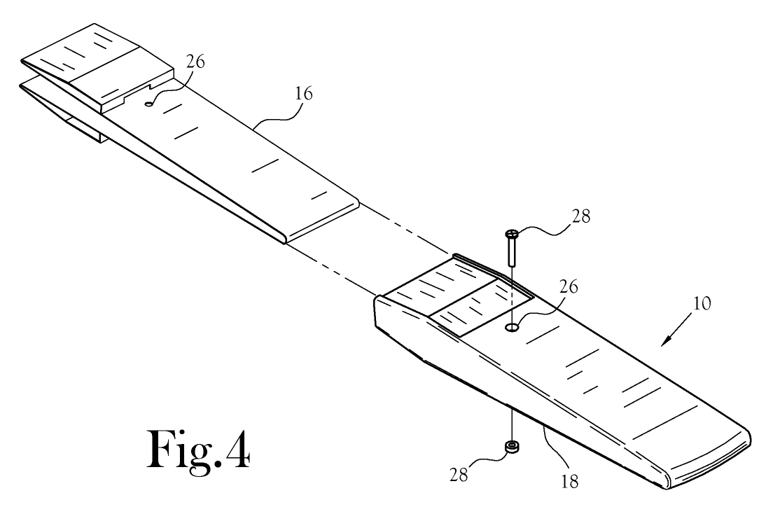

In several embodiments, the blade cover 10 is adapted to fasten to a lift blade 14 by fastener means. For example, in the illustrated embodiment the support structure 16 and the sleeve 18 cooperate to define a plurality of through borings 26. As shown in FIG. 4, the through borings 26 are each adapted to receive a fastener 28, such as a nut and bolt assembly. In this embodiment, the fasteners 28 also serve to further retain the sleeve 18 in place on the support structure 16. In several embodiments, the through borings 26 each include a recessed portion 44 for counter-sinking fasteners 28.

Referring to FIG. 1, in attaching the illustrated embodiment of the blade cover 10 to the lift blade 14, a plurality of holes are drilled through the lift blade 14 so as to have one hole in substantial registration with each through boring 26 when the blade cover 10 is placed to cover the toe 12. The lift blade 14 is then inserted into the opening 34, and the through borings 26 are aligned with the holes 30 in the lift blade 14. A fastener 28 is then fastened through each hole 30 and corresponding through boring 26 to secure the blade cover 10 to the lift blade 14.

While the present embodiment illustrates the use of nut and bolt assembly fasteners 28 to secure the blade cover 10 onto the lift blade 14, those skilled in the art will recognize numerous other devices and configurations suitable for use in securing the blade cover 10 in place around the lift blade 14. For example, in one embodiment, an adhesive fastener is provided between the support structure 16 and the lift blade 14. Such other devices and configurations for fastening the blade cover 10 in place may be used without departing from the spirit and scope of the present invention.

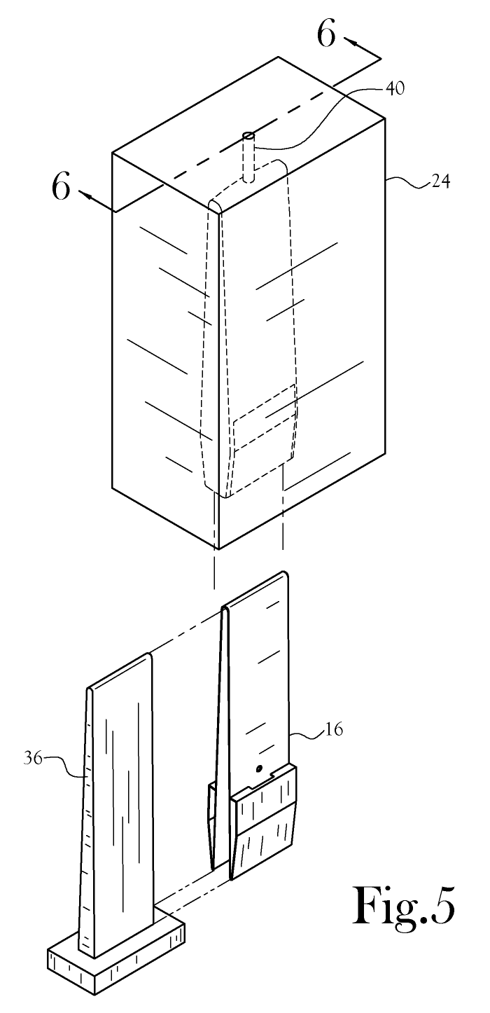

FIGS. 5-8 pertain to a method of manufacture of the blade cover 10. Referring to FIG. 5, a support structure 16 is formed of a substantially rigid material as described above. In one embodiment, the support structure 16 is forged from conventional steel. In another embodiment, the support structure 16 is cast from a molten metal. Those skilled in the art will recognize other methods suitable for forming the support structure 16, and such methods may be used without departing from the spirit and scope of the present invention.

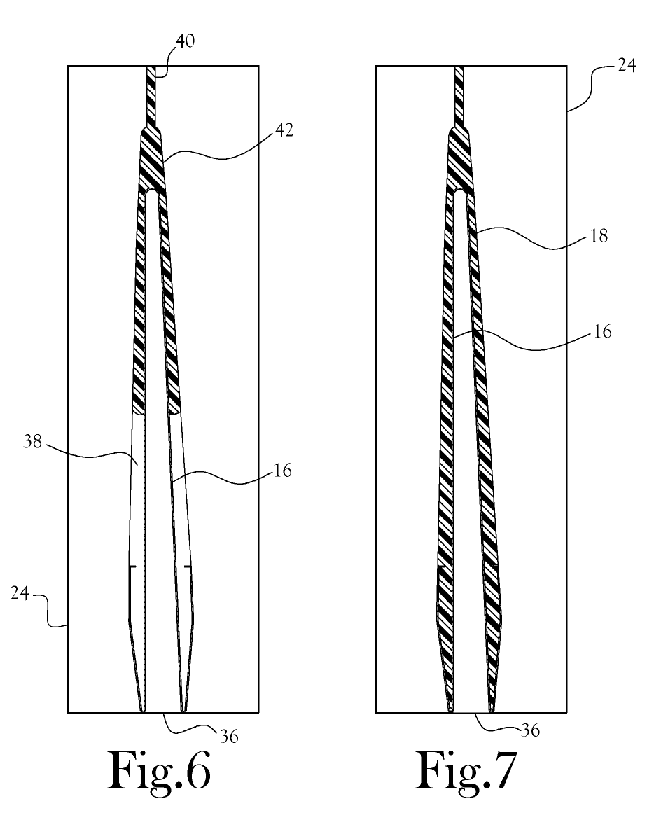

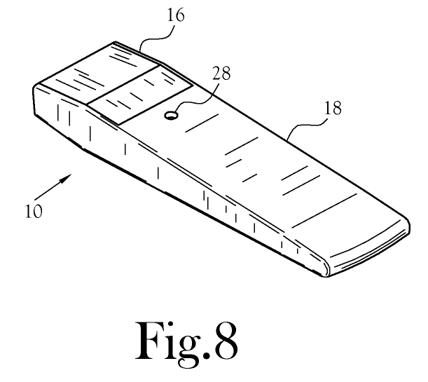

Once formed, the support structure 16 is placed onto a first mold 36. The first mold 36 and support structure 16 are then placed into a second mold 24. Referring to FIG. 6, the first and second molds 36, 24 cooperate with the support structure 16 to define a volume 38 suitable for forming the sleeve 18. The first and second molds 36, 24 further define at least one port 40 for receiving a measure of moldable material 42 into the volume 38. As shown in FIG. 6, an amount of uncured moldable material 42 is forced by an injection molding apparatus (not shown) into the volume 38. As shown in FIG. 7, the uncured moldable material 42 is then cured, forming the sleeve 18 around the support structure 16. The first and second molds 36, 24 are then removed from the support structure 16 and sleeve 18. As shown in FIG. 8, at an optional step, suitable openings are cut into the support structure 16 and sleeve 18 to accommodate fasteners 28 for securing the blade cover 10 to a lift blade.

Upon completion of the above-described method of manufacture, a blade cover 10 is formed providing a substantially rigid protective cover for a lift blade 14. The sleeve 18 serves to substantially surround and pad the exterior of the lift blade 14 and support structure 16 against damage to objects in the environment of the lift blade 14. The sleeve 18 further serves to prevent sparking resulting from impact of the toe 12, thereby providing increased safety against fire resulting from sparks from the lift blade 14 proximate hazardous material.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A blade cover for a forklift having at least one cantilevered lift blade adapted to support a load, the lift blade defining a toe extending from the forklift, said blade cover comprising:
a sleeve shaped to substantially surround the toe, said sleeve being fabricated from a layer of compressible, substantially resilient material, said sleeve defining an opening for receiving the lift blade distal end; and
a support structure received by said sleeve, said support structure being configured to support said sleeve in a substantially open configuration, said support structure being shaped to substantially register with the toe.

2. The blade cover of claim 1 further including at least one fastener for securing said sleeve to said support structure.

3. The blade cover of claim 2, said fastener being defined by a hook secured to said support structure, said hook covering and engaging a portion of said sleeve to secure said sleeve to said support structure.

4. The blade cover of claim 3, wherein said blade cover tapers toward said opening such as to provide a substantially smooth transition between said blade cover and the lift blade when said blade cover is in place surrounding the toe.

5. The blade cover of claim 3, wherein said sleeve substantially registers with said hooked portion such as to define a substantially smooth interface between said hook and said sleeve.

6. The blade cover of claim 1, said support structure being fabricated from a metal.

7. The blade cover of claim 1, said sleeve being fabricated from a material selected from the group consisting of rubber, glass fabric, and polymer.

8. The blade cover of claim 7, said support structure being fabricated from a metal.

9. The blade cover of claim 8 further including at least one fastener for securing said sleeve to said support structure.

10. The blade cover of claim 9, said fastener being defined by a hook secured to said support structure, said hook covering and engaging a portion of said sleeve to secure said sleeve to said support structure.

11. The blade cover of claim 10, wherein said blade cover tapers toward said opening such as to provide a substantially smooth transition between said blade cover and the lift blade when said blade cover is in place surrounding the toe.

12. The blade cover of claim 10, wherein said sleeve substantially registers with said hooked portion such as to define a substantially smooth interface between said hook and said sleeve.

13. A method for manufacturing a blade cover for a forklift having at least one cantilevered lift blade adapted to support a load, the lift blade defining a toe extending from the forklift, the method comprising the steps of:
a. providing a support structure shaped to substantially register with the toe;
b. forming a sleeve sized to register with the support structure, wherein the sleeve is fabricated from a layer of compressible, substantially resilient material; and
c. substantially surrounding the support structure with the sleeve

14. The method of claim 13, said steps of forming the sleeve and substantially surrounding the support structure with the sleeve further comprising the steps of:
a. providing a mold adapted to cooperate with the support structure to define a volume suitable for forming the sleeve, wherein the mold defines at least one port for receiving a measure of moldable material into the volume;
b. bringing the support structure into cooperative engagement with the mold to define the volume;
c. injecting an amount of uncured moldable material into the volume to substantially surround the support structure with uncured moldable material;
d. curing the uncured moldable material to form the sleeve substantially surrounding the support structure; and
e. removing the support structure and the sleeve from the mold.

15. The method of claim 14 further including the step of fastening the support structure to the sleeve.

16. The method of claim 15, said step of fastening the support structure to the sleeve including the steps of:
a. cutting a through opening into the support structure and sleeve to accommodate a fastener; and
b. inserting a fastener into the through opening.

17. The method of claim 14, said step of providing a support structure further including providing at least one hook secured to the support structure, wherein said step of injecting an amount of uncured moldable material into the volume includes allowing the at least one hook to engage the uncured moldable material.

18. The method of claim 13 further including the step of fastening the support structure to the sleeve.

19. The method of claim 15, said step of fastening the support structure to the sleeve including the steps of:
a. cutting a through opening into the support structure and sleeve to accommodate a fastener; and
b. inserting a fastener into the through opening.

20. The method of claim 13, said step of providing a support structure further including providing a hook secured to the support structure, wherein said step of injecting an amount of uncured moldable material into the volume includes allowing said hook to engage said uncured moldable material.
